(19) United States
(12) Patent Application Publication
(10) Pub. No.: US 2020/0217223 A1
(43) Pub. Date: Jul. 9, 2020

(54) Method for Distributing Relative Gap Parameters of Large-Scale High-Speed Rotary Equipment Components Based on Eccentricity Vector Following Measurement and Adjustment

(71) Applicant: Harbin Institute of Technology, Harbin (CN)

(72) Inventors: Jiubin TAN, Harbin (CN); Chuanzhi SUN, Harbin (CN); Yongmeng LIU, Harbin (CN)

(21) Appl. No.: 16/375,204

(22) Filed: Apr. 4, 2019

(30) Foreign Application Priority Data
Jan. 7, 2019 (CN) 201910012272.6

(51) Int. Cl. F01D 25/28; G06N 3/12; G06F 17/16; G06N 7/00

(52) U.S. Cl. CPC F01D 25/285; G06N 3/126; G06F 17/16; F05D 2220/323; F05D 2240/10; F05D 2240/24; G06N 7/005

(57) ABSTRACT

The present invention provides a method for distributing relative gap parameters of large-scale high-speed rotary equipment components based on eccentricity vector following measurement and adjustment. According to the present invention, a propagation process of location and orientation errors of rotors and stators of an aero-engine during assembly are analyzed, a propagation relationship of eccentricity errors after n-stage rotor and stator assembly is determined, and a coaxiality prediction model after multi-stage rotor and stator assembly is obtained; and the relative concentricity and relative runout of the rotors and stators can be further obtained by using an offset of the rotors and stators, thereby implementing the calculation of a relative gap; thereafter, a dual-objective optimization model for multi-stage rotor and stator coaxiality and relative gap amount based on an angular orientation mounting position of all stages of rotors and stators is established, the angular orientation mounting position of all stages of rotors and stators is optimized by using a genetic algorithm, to obtain an optimal mounting phase of all stages of rotors and stators; and finally, relative gap parameters of the rotor and stator can be distributed by using a probability density method.

### TECHNICAL FIELD

The present invention belongs to the technical field of mechanical assembly, and in particular, to a method for distributing relative gap parameters of large-scale high-speed rotary equipment components based on eccentricity vector following measurement and adjustment.

### BACKGROUND ART

An aero-engine is the “heart” of an aircraft, and its performance largely determines the performance of the aircraft. Multiple stages of rotors and stators are main components of the aero-engine. By increasing the manufacturing and assembly accuracy of the multiple stages of rotors and stators, the performance of the whole machine can be effectively improved, and the vibration of the aero-engine itself can be reduced.

The optimization of the multiple stages of rotors and stators is the research hotspot of the current aero-engine optimization design. The quality of manufacturing of a single-stage rotor or stator and the quality of assembly of the multiple stages of rotors and stators have a great influence on the performance of the aero-engine. At present, a rotor and stator relative gap parameter distribution method is urgently needed to improve the quality of manufacturing and assembly of rotors and stators. At present, the existing method only realizes the optimal measurement for an assembly geometric quantity of multiple stages of rotors and stators. An established coaxiality model does not consider rotation errors around X and Y axes, so an optimal measurement method for a relative gap amount between the rotors and stators have not been established.

### SUMMARY OF THE INVENTION

In order to solve the existing technical problems, the present invention is directed to a method for distributing relative gap parameters of large-scale high-speed rotary equipment components based on eccentricity vector following measurement and adjustment.

The present invention is implemented by the following technical solutions. The present invention provides a method for distributing relative gap parameters of large-scale high-speed rotary equipment components based on eccentricity vector following measurement and adjustment.

During multi-stage rotor and stator assembly, rotor and stator location and orientation errors are propagated and accumulated during the assembly process, an eccentricity error propagation matrix T₀₋ₙ caused by location and orientation errors of all stages of rotors and stators after n-stage rotor and stator assembly being:

$${T}_{0 - n} = [ \begin{matrix}{\prod }_{i = 1}^{n} {S}_{ri} {S}_{xi} {S}_{yi} & {\sum }_{i = 1}^{n} ( {\prod }_{j = 2}^{i} {S}_{rj - 1} {S}_{xj - 1} {S}_{yj - 1} ) {S}_{ri} ( {p}_{i} + {dp}_{i} ) \\ {0}^{T} & 1\end{matrix} ]$$

where pᵢ an ideal position vector of a center of a radial measurement plane of the ith stage of rotor or stator, dpᵢ is a machining error vector of a center position of the radial measurement plane of the ith stage of rotor or stator, Sᵣᵢ is a rotation matrix of the ith stage of rotor or stator rotating around a Z axis by an angle θᵣᵢ, Sᵣ₁ is a unit matrix, Sₓᵢ is a rotation matrix of the ith stage of rotor or stator reference plane rotating around an X axis by an angle θₓᵢ, S_{yi} is a rotation matrix of the ith stage of rotor or stator reference plane rotating around a Y axis by an angle θ_{yi}, Sₓⱼ₋₁ is a rotation matrix of a (j-1)th stage of rotor or stator reference plane rotating around a X axis by an angle θₓⱼ₋₁, S_{yj-1} is a rotation matrix of the (j-1)th stage of rotor or stator reference plane rotating around a Y axis by an angle θ_{yj-1}, and Sᵣⱼ₋₁ is a rotation matrix of the (j-1)th stage of rotor or stator reference plane rotating around a Z axis by an angle θᵣⱼ₋₁.

The kth stage of rotor or stator accumulative offset after n-stage rotor and stator assembly may be expressed as:

$$[ \begin{matrix}{dx}_{0 - k} \\ {dy}_{0 - k}\end{matrix} ] = [ \begin{matrix}1 & 0 & 0 \\ 0 & 1 & 0\end{matrix} ] \cdot {\sum }_{i = 1}^{k} ( {\prod }_{j = 2}^{i} {S}_{rj - 1} {S}_{xj - 1} {S}_{yj - 1} ) {S}_{ri} ( {p}_{i} + {dp}_{i} )$$

where dx₀₋ₖ is the accumulative offset of a center of a measurement plane of the kth stage of rotor or stator in an X-axis direction after n-stage rotor and stator assembly, and dy₀₋ₖ is the accumulative offset of the center of the measurement plane of the kth stage of rotor or stator in a Y-axis direction after n-stage rotor and stator assembly.

According to an ISO standard definition of coaxiality, an expression of coaxiality after n-stage rotor and stator assembly is:

coaxiality=max{2\sqrt{dx²₀₋ₖ+dy²₀₋ₖ}, k=1,2, . . . , n}

A coaxiality prediction model after multi-stage rotor and stator assembly is established accordingly.

An offset after multi-stage rotor and stator assembly is analyzed, and the relative concentricity and relative runout of a rotor and a stator can be obtained by calculating offsets of the rotor and the stator, so as to implement the calculation of a relative gap after multi-stage rotor and stator assembly.

A dual-objective optimization model for multi-stage rotor and stator coaxiality and relative gap amount based on an angular orientation mounting position of all stages of rotors and stators is established according to a relationship between multi-stage rotor and stator coaxiality, relative concentricity, relative runout and angular orientation mounting position, and the angular orientation mounting position of all stages of rotors and stators is optimized by using a genetic algorithm, so that an optimal mounting phase of all stages of rotors and stators can be obtained.

An objective function of a relative gap can be obtained by using a multi-stage rotor and stator relative gap measurement model, then the probability density of the relative gap is further obtained, and then a probability relationship between contact surface runout information and relative gaps is obtained, so that relative gap parameters of a multi-stage rotor and stator can be distributed.

### BRIEF DESCRIPTION OF THE DRAWINGS

FIG. 1 is a flowchart of a relative gap parameter distribution method according to the present invention.

### DETAILED DESCRIPTION OF THE INVENTION

The technical solutions in the embodiments of the present invention are clearly and completely described in the following with reference to the drawings in the embodiments of the present invention. It is obvious that the described embodiments are only a part of the embodiments of the present invention, and not all of the embodiments. All other embodiments obtained by a person of ordinary skill in the art based on the embodiments of the present invention without creative efforts are within the scope of protection of the present invention.

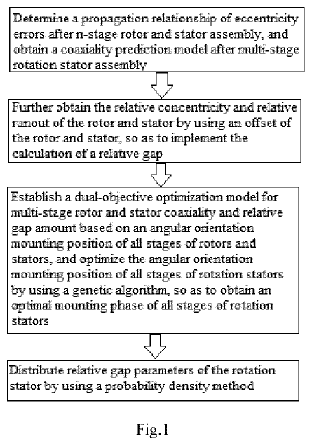

Referring to FIG. 1, the present invention provides a method for distributing relative gap parameters of large-scale high-speed rotary equipment components based on eccentricity vector following measurement and adjustment.

During multi-stage rotor and stator assembly, rotor and stator location and orientation errors are propagated and accumulated during the assembly process, an eccentricity error propagation matrix T₀₋ₙ caused by location and orientation errors of all stages of rotors and stators after n-stage rotor and stator assembly being:

$${T}_{0 - n} = [ \begin{matrix}{\prod }_{i = 1}^{n} {S}_{ri} {S}_{xi} {S}_{yi} & {\sum }_{i = 1}^{n} ( {\prod }_{j = 2}^{i} {S}_{rj - 1} {S}_{xj - 1} {S}_{yj - 1} ) {S}_{ri} ( {p}_{i} + {dp}_{i} ) \\ {0}^{T} & 1\end{matrix} ]$$

where pᵢ is an ideal position vector of a center of a radial measurement plane of the ith stage of rotor or stator, dpᵢ is a machining error vector of a center position of the radial measurement plane of the ith stage of rotor or stator, Sᵣᵢ is a rotation matrix of the ith stage of rotor or stator rotating around a Z axis by an angle θᵣᵢ, Sᵣ₁ is a unit matrix, Sₓᵢ is a rotation matrix of the ith stage of rotor or stator reference plane rotating around an X axis by an angle θₓᵢ, S_{yi} is a rotation matrix of the ith stage of rotor or stator reference plane rotating around a Y axis by an angle θ_{yi}, Sₓⱼ₋₁ is a rotation matrix of a (j-1)th stage of rotor or stator reference plane rotating around a X axis by an angle θₓⱼ₋₁, S_{yj-1} is a rotation matrix of the (j-1)th stage of rotor or stator reference plane rotating around a Y axis by an angle θ_{yj-1} and Sᵣⱼ₋₁ is a rotation matrix of the (j-1)th stage of rotor or stator reference plane rotating around a Z axis by an angle θᵣⱼ₋₁.

The kth stage of rotor or stator accumulative offset after n-stage rotor and stator assembly is expressed as:

$$[ \begin{matrix}{dx}_{0 - k} \\ {dy}_{0 - k}\end{matrix} ] = [ \begin{matrix}1 & 0 & 0 \\ 0 & 1 & 0\end{matrix} ] \cdot {\sum }_{i = 1}^{k} ( {\prod }_{j = 2}^{i} {S}_{rj - 1} {S}_{xj - 1} {S}_{yj - 1} ) {S}_{ri} ( {p}_{i} + {dp}_{i} )$$

where dx₀₋ₖ is the accumulative offset of a center of a measurement plane of the kth stage of rotor or stator in an X-axis direction after n-stage rotor and stator assembly, and dy₀₋ₖ is the accumulative offset of the center of the measurement plane of the kth stage of rotor or stator in a Y-axis direction after n-stage rotor and stator assembly.

According to an ISO standard definition of coaxiality, an expression of coaxiality after n-stage rotor and stator assembly is:

coaxiality=max{2\sqrt{dx²₀₋ₖ+dy²₀₋ₖ}, k=1,2, . . . , n}

A coaxiality prediction model after multi-stage rotor and stator assembly is established accordingly.

An offset after multi-stage rotor and stator assembly is analyzed, the relative concentricity and relative runout of a rotor and a stator can be obtained by calculating offsets of the rotor and the stator, so that the calculation of a relative gap between rotor and stator after multi-stage rotor and stator assembly is implemented.

A dual-objective optimization model for multi-stage rotor and stator coaxiality and relative gap amount based on an angular orientation mounting position of all stages of rotors and stators is established according to a relationship between multi-stage rotor and stator coaxiality, relative concentricity, relative runout and angular orientation mounting position, and the angular orientation mounting position of all stages of rotors and stators is optimized by using a genetic algorithm, so that an optimal mounting phase of all stages of rotors and stators can be obtained.

An objective function of a relative gap can be obtained by using a multi-stage rotor and stator relative gap measurement model, then the probability density of the relative gap is further obtained, and then a probability relationship between contact surface runout information and relative gaps is obtained, so that relative gap parameters of a multi-stage rotor and stator can be distributed.

According to the present invention, a propagation process of location and orientation errors of a rotor and stator of an aero-engine during assembly are analyzed, a propagation relationship of eccentricity errors after n-stage rotor and stator assembly is determined, and a coaxiality prediction model after multi-stage rotor and stator assembly is obtained; the relative concentricity and relative runout of the rotor and stator can be further obtained by using an offset of the rotor and stator, so that the calculation of a relative gap is implemented; thereafter, a dual-objective optimization model for multi-stage rotor and stator coaxiality and relative gap amount based on an angular orientation mounting position of all stages of rotors and stators is established, and the angular orientation mounting position of all stages of rotors and stators is optimized by using a genetic algorithm, so that an optimal mounting phase of all stages of rotors and stators is obtained; and finally, relative gap parameters of the rotor and stator can be distributed by using a probability density method.

The above is a detailed description of the method for distributing relative gap parameters of large-scale high-speed rotary equipment components based on eccentricity vector following measurement and adjustment provided by the present invention. The principle and implementation of the present invention are described herein by using specific examples. The foregoing descriptions for the embodiments are only used to help understand the method of the present invention and its core ideas; at the same time, for a person of ordinary skill in the art, according to the idea of the present invention, there will be changes in specific implementations and application scopes. To sum up, the description is not to be construed as limiting the present invention.

1. A method for distributing relative gap parameters of large-scale high-speed rotary equipment components based on eccentricity vector following measurement and adjustment, wherein during multi-stage rotor and stator assembly, rotor and stator location and orientation errors are propagated and accumulated during the assembly process, an eccentricity error propagation matrix T₀₋ₙ caused by location and orientation errors of all stages of rotors and stators after n-stage rotor and stator assembly being:
$${T}_{0 - n} = [ \begin{matrix}{\prod }_{i = 1}^{n} {S}_{ri} {S}_{xi} {S}_{yi} & {\sum }_{i = 1}^{n} ( {\prod }_{j = 2}^{i} {S}_{rj - 1} {S}_{xj - 1} {S}_{yj - 1} ) {S}_{ri} ( {p}_{i} + {dp}_{i} ) \\ {0}^{T} & 1\end{matrix} ]$$
where pᵢ is an ideal position vector of a center of a radial measurement plane of an ith stage of rotor or stator, dpᵢ is a machining error vector of a center position of the radial measurement plane of the ith stage of rotor or stator, Sᵣᵢ is a rotation matrix of the ith stage of rotor or stator rotating around a Z axis by an angle θᵣᵢ, Sᵣ₁ is a unit matrix, Sₓᵢ is rotation matrix of the ith stage of rotor or stator reference plane rotating around an X axis by an angle θₓᵢ, S_{yi} is a rotation matrix of the ith stage of rotor or stator reference plane rotating around a Y axis by an angle θ_{yi}, Sₓⱼ₋₁ is a rotation matrix of a (j-1)th stage of rotor or stator reference plane rotating around an X axis by an angle θₓⱼ₋₁, S_{yj-1} is a rotation matrix of the (j-1)th stage of rotor or stator reference plane rotating around a Y axis by an angle θ_{yj-1}, and Sᵣⱼ₋₁ is a rotation matrix of the (j-1)th stage of rotor or stator reference plane rotating around a Z axis by an angle θᵣⱼ₋₁;
wherein the accumulative offset of a kth stage rotor or stator after n-stage rotor and stator assembly is expressed as:
$$[ \begin{matrix}{dx}_{0 - k} \\ {dy}_{0 - k}\end{matrix} ] = [ \begin{matrix}1 & 0 & 0 \\ 0 & 1 & 0\end{matrix} ] \cdot {\sum }_{i = 1}^{k} ( {\prod }_{j = 2}^{i} {S}_{rj - 1} {S}_{xj - 1} {S}_{yj - 1} ) {S}_{ri} ( {p}_{i} + {dp}_{i} )$$
where dx₀₋ₖ is the accumulative offset of a center of a measurement plane of the kth stage of rotor or stator in an X-axis direction after n-stage rotor and stator assembly, and dy₀₋ₖ is the accumulative offset of the center of the measurement plane of the kth stage of rotor or stator in a Y-axis direction after n-stage rotor and stator assembly;
wherein, according to an ISO standard definition of coaxiality, an expression of coaxiality after n-stage rotor and stator assembly is:
coaxiality=max{2\sqrt{dx²₀₋ₖ+dy²₀₋ₖ}, k=1,2, . . . , n}
a coaxiality prediction model after multi-stage rotor and stator assembly is established accordingly;
wherein an offset after multi-stage rotor and stator assembly is analyzed, the relative concentricity and relative runout of a rotor and a stator can be obtained by calculating offsets of the rotor and the stator, and the calculation of a relative gap after multi-stage rotor and stator assembly is implemented;
wherein a dual-objective optimization model for multi-stage rotor and stator coaxiality and relative gap amount based on an angular orientation mounting position of all stages of rotors and stators is established according to a relationship between multi-stage rotor and stator coaxiality, relative concentricity, relative runout and angular orientation mounting position, the angular orientation mounting position of all stages of rotors and stators is optimized by using a genetic algorithm, so that an optimal mounting phase of all stages of rotors and stators can be obtained; and
wherein an objective function of a relative gap can be obtained by using a multi-stage rotor and stator relative gap measurement model, then the probability density of the relative gap is further obtained, and then a probability relationship between contact surface runout information and relative gaps is obtained, so that relative gap parameters of a multi-stage rotor and stator are distributed.
